(19) United States
(12) Patent Application Publication
(10) Pub. No.: US 2025/0369417 A1
(43) Pub. Date: Dec. 4, 2025

(54) PROPELLOR SYSTEM WHICH IS SUITABLE FOR KINETIC INTERACTION WITH A FLUID THAT FLOWS UNIDIRECTIONALLY THROUGH A CHANNEL, AND A CHANNEL FOR A UNIDIRECTIONAL FLUID FLOW PROVIDED WITH SUCH A PROPELLOR SYSTEM

(71) Applicant: HTP TECHNOLOGIES B.V., Willemstad (CW). (NL)

(72) Inventors: Johannes Willem VAN BRIEMEN, Baarn (NL); Ronald VAN DIJK, Delft (NL)

(73) Assignee: TURTLE PROP HTP HOLDING B.V., Amsterdam (NL)

(21) Appl. No.: 18/874,866

(22) PCT Filed: Jun. 12, 2023
(86) PCT No.: PCT/NL2023/050323

§ 371 Date: Dec. 13, 2024

(30) Foreign Application Priority Data
Jun. 15, 2022 (NL) 2032174

(51) Int. Cl. F03B 17/06

(52) U.S. Cl. CPC F03B 17/065; F05B 2240/40; F05B 2250/312; F05B 2260/503

(57) ABSTRACT

Propellor system which is suitable for kinetic interaction with a fluid that flows unidirectionally through a channel, wherein the propellor system comprises a supporting body which is configured to be integrated within the channel in a fixed position, and a kinetic interaction system which is provided on the supporting body such that the kinetic interaction system extends in an interior area of the channel when the supporting body is integrated in the fixed position, wherein the kinetic interaction system is provided with cither at least one pair of rotatory blades, or a single rotatory blade, and wherein each rotatory blade performs a combinatory rotation.

The present invention relates to a propellor system which is suitable for kinetic interaction with a fluid that flows unidirectionally through a channel. The invention furthermore relates to a channel for a unidirectional fluid flow which is provided with such a propellor system.

The propellor system according to the invention is suitable to transfer kinetic energy from the propellor system to a unidirectional fluid flow in the channel, wherein the propellor system exerts a thrust on the fluid flow by which the fluid flow is accelerated. Such an application is useful for aquatic means of transportation, for instance as a propellor for ships.

Furthermore, the propellor system is suitable for the transfer of kinetic energy in a reversed manner, wherein kinetic energy of a fluid flow that is led through the channel drives the propellor system to be moved, such that the kinetic energy of the fluid flow is harvested by the propellor system and can be used subsequently, such as for the conversion into electromagnetic, hydraulic, pneumatic or mechanical energy. Such an application is for instance useful in turbine systems for the creation of electromagnetic energy.

The below description is mainly focused on the first application for exerting a thrust on the fluid flow. However, it is noted that the same advantages apply vice versa to the reverse application of harvesting kinetic energy from the fluid flow by the propellor system.

Propellor systems are well known for their use in ship propulsion, and are generally based on a design of a ship propellor having several propellor blades which are rotated through the water. Although a high propulsion energy is attainable by such a ship propellor, the purely rotational motion of the blades leads to some energy losses which reduce the efficacy and hence the efficiency of the kinetic interaction of the ship propellor with the water.

In view of the prior art, the invention is directed to providing a fundamentally different design of a propellor system that kinetically interacts with a fluid flow, which has an attractive efficacy and hence an attractive efficiency of kinetic interaction in comparison to the prior art propellor systems.

In order to achieve the above objective, a first aspect of the invention relates to the provision of:
a propellor system which is suitable for kinetic interaction with a fluid that flows unidirectionally through a channel,
wherein the propellor system comprises a supporting body which is configured to be integrated within the channel in a fixed position, and a kinetic interaction system which is provided on the supporting body such that the kinetic interaction system extends in an interior area of the channel when the supporting body is integrated in the fixed position,
wherein the kinetic interaction system includes either:
   (i) at least one pair of rotatory blades, preferably at least two pairs of rotatory blades, wherein each pair of rotatory blades is provided in such a way that:
each rotatory blade has a planar shape comprising two opposite, operational surfaces which are designed for kinetic interaction with a fluid flow;
each rotatory blade comprises a respective blade axis over which the rotatory blade is rotatable, and a respective blade gearing which is drivingly engaged to the blade axis;
the two rotatory blades are rotatably mounted by means of their respective blade axes onto one side of a common wheel and at a distance from each other, wherein the common wheel comprises a wheel axis over which the common wheel is rotatable, and wherein the two blade axes are mounted onto the common wheel at two respective positions which are both eccentric to the wheel axis,
the common wheel is rotatably connected to the supporting body by virtue of the wheel axis, and is drivingly connected to a wheel gearing;
the rotation of the common wheel drives the two blade gearings in order to rotate the two blade axes simultaneously;
the configuration of the kinetic interaction system is such that the two blade axes and the wheel axis have a similar, or parallel, direction to each other;
during operation of the propellor system, the rotation of the common wheel in combination with the simultaneous rotation of each rotatory blade over its blade axis results in a combinatory rotation being performed by each rotatory blade, wherein each rotatory blade follows a cyclic trajectory per revolution of the common wheel, while the two rotatory blades do not contact with each other during their simultaneous rotations, or
   (ii) a single rotatory blade, which is provided in such a way that:
the rotatory blade has a planar shape comprising two opposite, operational surfaces which are designed for kinetic interaction with a fluid flow;
the rotatory blade comprises a respective blade axis over which the rotatory blade is rotatable, and a respective blade gearing which is drivingly engaged to the blade axis;
the rotatory blade is rotatably mounted by means of its blade axis onto one side of a common wheel, wherein the common wheel comprises a wheel axis over which the common wheel is rotatable, and wherein the blade axis is mounted onto the common wheel at a position which is eccentric to the wheel axis,
the common wheel is rotatably connected to the supporting body by virtue of the wheel axis, and is drivingly connected to a wheel gearing;
the rotation of the common wheel drives the blade gearing in order to rotate the blade axis;
the configuration of the kinetic interaction system is such that the blade axis and the wheel axis have a similar, or parallel, direction to each other;
during operation of the propellor system, the rotation of the common wheel in combination with the simultaneous rotation of the rotatory blade over its blade axis results in a combinatory rotation being performed by the rotatory blade, wherein the rotatory blade follows a cyclic trajectory per revolution of the common wheel.

Such a propellor system with a kinetic interaction system according to either option (i) or (ii), allows the rotatory blade to exert a thrusting force onto the unidirectional fluid flow during a thrusting phase of its cyclic trajectory, wherein the operational surfaces of the blade assume an active orientation when being moved in a direction that follows the unidirectional fluid flow, while during a complementary phase of the cyclic trajectory the operational surfaces of the blade assume an idle orientation when being moved in a direction against the unidirectional fluid flow. The propellor system is therefore highly effective in transferring its kinetic energy onto a flow of fluid in a channel.

Additionally, when the propellor system includes a kinetic system according to option (ii), the pair of rotatory blades per common wheel allows for exerting successive thrusting power upon the fluid flow by the two blades in an alternating way during one revolution of the common wheel, which results in a relatively constant thrust power of the propellor system per revolution of the common wheel, which further contributes to the efficiency of the propellor system.

It is preferred in the propellor system according to the invention, that the cyclic trajectory that the rotatory blade follows is conform the shape of a cardioid curve, in particular in view of the cyclic trajectory of a lateral end part of the rotatory blade.

Such a cyclic trajectory was found highly suitable for improving the efficiency and efficacy of the propellor system, especially in view of improving the kinetic interaction with a fluid flow.

It is noted for clarity, that as a result of the combinatory rotation of the rotatory blade, all parts of the rotatory blade which do not coincide with the blade axis will follow a cyclic trajectory having the shape of a cardioid curve. This aspect of the cyclic trajectory is most prominent when following the lateral end parts of the rotatory blade. The cyclic trajectory of the lateral end parts furthermore delimits the area wherein the rotatory blade will be moving during operation.

Further preferred in the propellor system according to the invention, is that the cyclic trajectory of the two rotatory blades within one pair is similar or identical.

This assures that the kinetic interaction of the fluid flow with the two rotatory blades within one pair is similar or identical during operation, which contributes to the efficacy of the propellor system.

In a preferred embodiment of the propellor system according to the invention, the blade gearing of each rotatory blade has a gearing ratio of 1/2, such that one revolution of the common wheel results in half a rotation of the rotatory blade over its blade axis.

Such a gearing ratio achieves that the orientation of the rotatory blade is 180 degrees rotated upon a next revolution of the common wheel, which is advantageous to the efficacy of the propellor system. The opposed operational surfaces are both designed for kinetical interaction with the fluid flow, and have thus a similar design. Therefore, the effective orientation of the rotatory blade is repeated during each revolution although a different side (i.e. operational surface of the blade) is facing the fluid flow. As such, the rotatory blade assumes the same orientation after a successive, complete revolution of the common wheel.

In a next preferred embodiment of the propellor system according to the invention, the blade axes of two rotatory blades within each pair of rotatory blades are mounted onto the common wheel in opposed positions with respect to the wheel axis, preferably in diametrically opposed positions.

Such a positioning of the rotatory blades by their respective blade axes results in a sequence of successive rotatory blades performing their kinetic interactions at equal time intervals, thus achieving a more constant thrust power per revolution of the common wheel.

It is further preferred in the propellor system according to the invention, that during operation of the propellor system, the two rotatory blades within one pair execute their respective combinatory rotations simultaneously and with a phase difference, preferably a phase difference between 160 and 200 degrees, most preferably 180 degrees.

By the phase difference between the two combinatory rotations, the orientations of the rotatory blades are complementary to each other, and occur successively at equal time intervals.

It is also preferred in the propellor system according to the invention, that during one revolution of the common wheel, the rotatory blade assumes an idle (inactive or drag) orientation for minimum kinetic interaction during a first half of the revolution of the common wheel, and the rotatory blade assumes an active (thrust) orientation for maximum kinetic interaction during a second half of the revolution of the common wheel.

During the first half of the revolution, the idle orientation of the rotatory blade is assumed by a substantially parallel orientation of the operational surfaces of the rotatory blade with respect to the unidirectional fluid flow. During the second half of the revolution, the active orientation of the rotatory blade is assumed by a substantially perpendicular orientation of the operational surfaces of the rotatory blade with respect to the unidirectional fluid flow.

Such a configuration is especially effective, when the propellor system is fixed within the channel in such a way, that the first half of the revolution involves the blade axis of the rotatory blade moving against the direction of the fluid flow, while the second half of the revolution involves the blade axis of the rotatory blade moving with the direction of the fluid flow.

In a further preferred embodiment of the propellor system according to the invention, the rotational speed of the rotatory blade, during one complete revolution of the common wheel, gradually increases from a minimum rotational speed to a maximum rotational speed and subsequently gradually decreases from the maximum rotational speed to the minimum rotational speed, wherein preferably the ratio of maximum rotational speed versus minimum rotational speed is about 2:1.

In the propellor system according to the invention, it is particularly preferred that the maximum rotational speed is achieved during the first half of the complete revolution of the common wheel wherein the idle orientation of the rotatory blade is assumed, and the minimum rotational speed is achieved during the second half of the complete revolution of the common wheel wherein the active orientation of the rotatory blade is assumed.

In the propellor system, the maximum kinetic interaction is achieved in active orientation of the blade (i.e substantially perpendicular to the unidirectional fluid flow). When this orientation is assumed in a phase of rotation wherein simultaneously a lower rotational speed is observed, an effectively longer period for kinetic interaction with the fluid flow is achieved. Consequently, the efficacy of the kinetic interaction of the propellor system is enhanced.

During this phase of thrust, the blade is thus moved by a translation in an axial direction that is aligned with the unidirectional fluid flow, while the rotational motion of the blades is kept minimum when the thrusting force is exerted.

Especially preferred in the propellor system according to the invention, is that the blade gearing for each rotatory blade includes an elliptic or oval gear co-operating with a circular gear, wherein preferably the circular gear is an eccentrically rotating, circular gear.

Such a blade gearing achieves a rotational speed of the rotatory blade which gradually oscillates between a maximum and minimum rotational speed.

Alternatively, the gradual oscillation between a maximum and minimum rotational speed may be accomplished in a different way, such as by using a microprocessor controlled stepper electro engine which is programmed to execute such an oscillating rotational speed.

It is especially preferred in the propellor system according to the invention, that the blade gearing for each rotatory blade is mounted on the respective common wheel, wherein the blade gearing is positioned such that it includes one connecting gear that engages with a non-rotatory gear fixated onto the supporting body in a position concentric with the wheel axis.

This combination of interacting gears is highly suitable to perform the combinatory rotation of the rotatory blade, while it is driven by the rotation of the common wheel.

Further preferred in the propellor system according to the invention, is that each rotatory blade has a height and a width, wherein the blade axis extends parallel to the height direction of the rotatory blade, and preferably the height of the rotatory blade is larger than the width of the rotatory blade.

Such a dimensioning of the rotatory blade is highly suitable for executing the specific combinatory rotations while achieving an effective and efficient kinetic interaction with a fluid flow.

It is particularly attractive when the height and the width of the rotatory blade are substantially constant over the whole rotatory blade. Alternatively, the width of the rotatory blade may gradually taper towards its middle height in comparison to the width at the upper and lower ends of the rotatory blade.

Preferably, in the propellor system according to the invention, the opposed operational surfaces of each rotatory blade are similar or identical, and are substantially shaped as planar surfaces which are preferably provided with curved lateral end sections when viewed in cross-section perpendicular to the height direction of the rotatory blade.

In a particularly preferred propellor system according to the invention, the kinetic interaction system comprises a first pair of rotatory blades and a second pair of rotatory blades,
wherein the first pair of rotatory blades is rotatably connected to a first common wheel, and the second pair of rotatory blades is rotatably connected to a second common wheel,
wherein the first common wheel and second common wheel are rotatably connected to the supporting body such that the first common wheel and second common wheel are arranged adjacent to each other in a coplanar configuration, and are drivingly connected to a respective first and second wheel gearing, wherein preferably the first common wheel and the second common wheel rotate in opposite directions to each other during operation.

A rotation in opposite directions may expediently be accomplished by providing each of the two circumferences of the first common wheel and the second common wheel with a toothed gearing which directly engage with each other.

This preferred, dual configuration of two pairs of rotatory blades offers the possibility of an enhanced kinetic interaction with the unidirectional fluid flow because both the first and second pair of rotatory blades contribute in a synergetic manner by substantially exerting their combined thrusting power onto the major part of the fluid flow (i.e. the central part of the fluid flow).

The above described enhanced kinetic interaction of the dual configuration with two pairs of rotatory blades is particularly effective, when during one revolution of each common wheel, the rotatory blade assumes an idle (inactive or drag) orientation for minimum kinetic interaction during a first half of the revolution of the common wheel, and the rotatory blade assumes an active (thrust) orientation for maximum kinetic interaction during a second half of the revolution of the common wheel, in such a way that the rotatory blades of both pairs assume an active orientation at a relatively short distance from each other and assume an idle orientation at a relatively large distance from each other.

In the propellor system according to the invention, it is further preferred that the first pair of rotatory blades and the second pair of rotatory blades rotate in opposite directions and in mirror symmetry to each other, and that the rotational phase of the rotatory blades of the first common wheel and the rotational phase of the rotatory blades of the second common wheel are different from each other by a phase difference of 60 to 120 degrees, preferably 80 to 100 degrees, more preferably 90 degrees.

As such, the four successive active orientations of the rotatory blades of the two pairs are only separated from each other by an even smaller phase difference than achievable within one pair. This further contributes to achieving a more constant thrusting power of the propellor system.

It is particularly interesting when, in the propellor system according to the invention, the cyclic trajectory of the rotatory blades of the first pair partially overlaps with the cyclic trajectory of the rotatory blades of the second pair, in particular in view of the cyclic trajectory of the lateral end part of each rotatory blade.

This further contributes to achieving a synergetic thrusting power achieved by the combination of the two pair of rotatory blades.

When the propellor system according to the invention comprises a kinetic interaction system according to option (ii), it is especially preferred that the propellor system comprises a first kinetic interaction system according to option (ii), and a second kinetic interaction system according to option (ii), wherein the first kinetic interaction comprises a single rotatory blade that is rotatably connected to a first common wheel, and the second kinetic interaction comprises a single rotatory blade that is rotatably connected to a second common wheel,
wherein the first common wheel and the second common wheel are rotatably connected to the supporting body such that the first common wheel and second common wheel are arranged adjacent to each other in a coplanar configuration, and are drivingly connected to a respective first and second wheel gearing, wherein preferably the first common wheel and the second common wheel rotate in opposite directions to each other during operation.

In the context of the above preferred embodiment of the propellor system comprising a kinetic interaction system according to option (ii), it is particularly preferred that the single rotatory blade of the first kinetic interaction system and the single rotatory blade of the second kinetic interaction system rotate in opposite directions and in mirror symmetry to each other, and the rotational phase of the first common wheel and the second common wheel are different from each other by a phase difference, preferably a phase difference between 160 and 200 degrees, most preferably 180 degrees.

Furthermore In the context of the above preferred embodiment of the propellor system comprising a kinetic interaction system according to option (ii), it is preferred that the cyclic trajectory of the single rotatory blade of the first kinetic interaction system overlaps with the cyclic trajectory of the single rotatory blade of the second kinetic interaction system, in particular in view of the cyclic trajectory of the lateral end part of each rotatory blade.

In a second aspect, the invention relates to:
a channel for conducting a unidirectional fluid flow, which comprises side walls and an entry side and an exit side for unidirectionally conducting a flow of fluid from the entry side to the exit side, which channel is provided with a propellor system according to the first aspect of the invention,
wherein the supporting body of the propellor system is fixedly integrated within the channel, and the kinetic interaction system of the propellor system includes at least one common wheel which is provided in such a way that:
during one revolution of each common wheel, the rotatory blade assumes an idle (inactive or drag) orientation for minimum kinetic interaction during a first half of the revolution of the common wheel, and the rotatory blade assumes an active (thrust) orientation for maximum kinetic interaction during a second half of the revolution of the common wheel;
each common wheel rotates against the unidirectional flow of fluid in the channel during its first half of revolution, and the common wheel rotates with the unidirectional flow of fluid in the channel during its second half of revolution,
   wherein the first half of the revolution is performed at a small distance from a nearest side wall of the channel whereas the second half of the revolution is performed at a large distance from the nearest side wall of the channel.

In such a channel the kinetic interaction with the unidirectional fluid flow occurs for the major part in the second half of the revolution, and it is hydrodynamically advantageous to have this second half being distanced from the nearest side wall. Conversely, it is also hydrodynamically attractive when the first half during which an idle orientation is assumed, is performed close to the nearest side wall of the channel.

The above advantages of distance to the are even more prominent, when the propellor system has a dual configuration with two adjacent common wheels as discussed above.

In a particularly preferred embodiment of the channel according to the invention, the propellor system is fixedly integrated in a longitudinal section of the channel through which the fluid flow is conducted, which longitudinal section has a width between opposed side walls of the channel which width is not more than 20% larger, preferably not more than 10% larger, than the width necessary for allowing the rotatory blades to execute their respective cyclic trajectories during operation without contacting the opposed side walls.

Such a dimensioning of the channel assures the most effective and hence efficient kinetic interaction of the propellor system with the unidirectional fluid flow that is conducted through the channel.

In regard of the propellor system being suitable for different purposes, some specific arrangements have been observed that were highly effective in practice.

When the propellor system is applied for exerting a thrust on a fluid flow such as in an engine for propulsion of a ship, a vertical orientation of the propellor system within the ship proved particularly effective. In this context, the vertical orientation of the propellor system is achieved when the blade axis of each rotatory blade is oriented in a direction parallel or similar to the vertical axis of the ship on which the propellor system is fixedly mounted.

Furthermore, it was found that when the propellor system is applied for harvesting kinetic energy from a fluid flow, it is attractive when the propellor system is fixedly mounted such that it is horizontally oriented to the environment. The horizontal orientation is achieved when the blade axis of each rotatory blade is oriented in a direction parallel or similar to the horizontal plane of the environment.

The invention will be further elucidated by the appended figures, showing preferred embodiments of the invention, wherein:

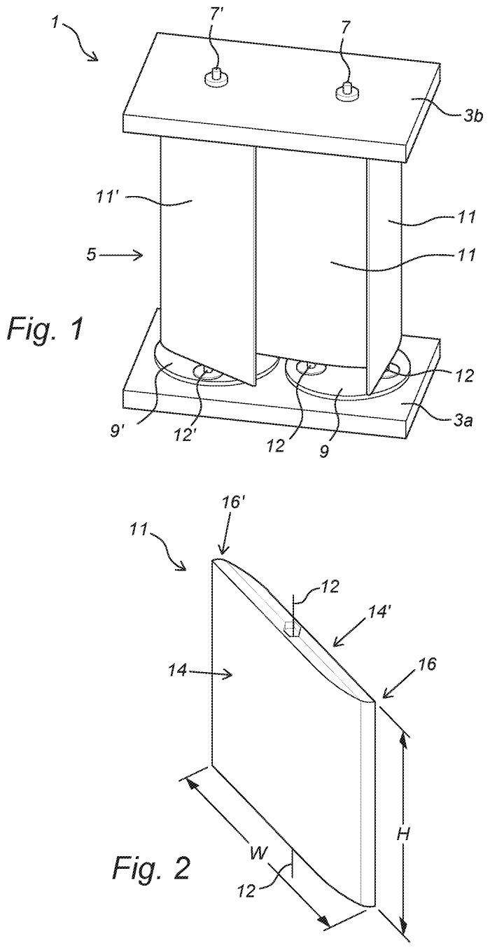

FIG. 1 shows a propellor system according to the invention in a dual configuration;

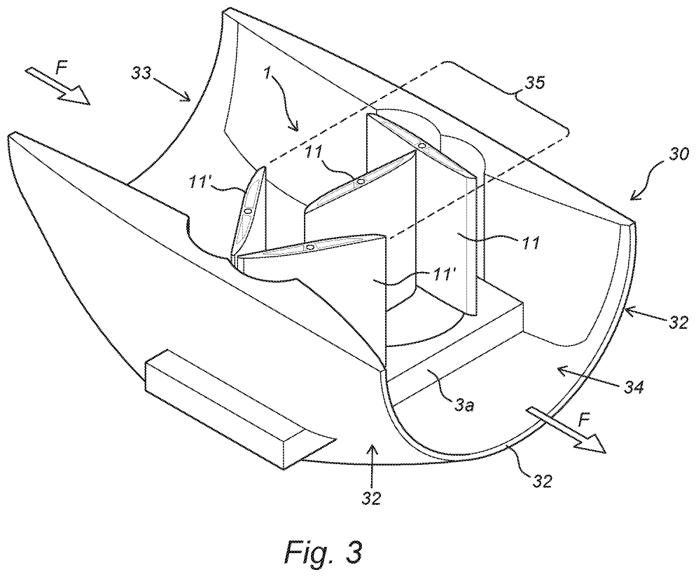

FIG. 2 shows a single rotatory blade;

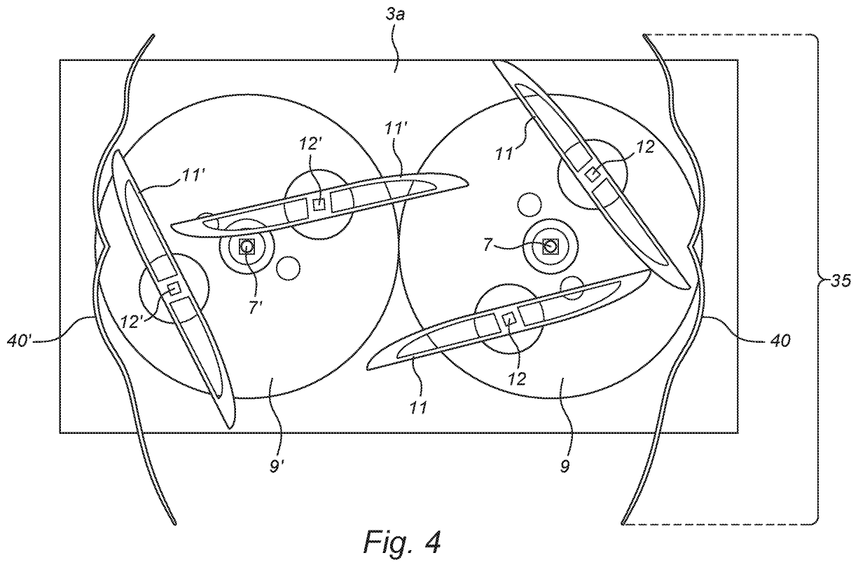

FIG. 3 shows a cross-sectioned part of a channel provided with a propellor system according to FIG. 1;

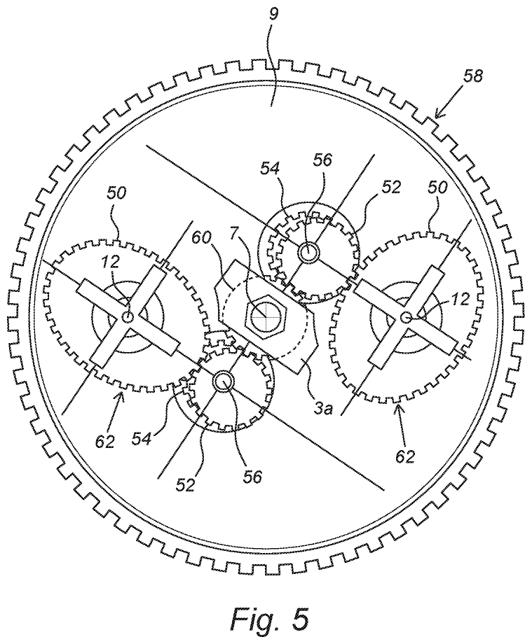

FIG. 4 shows a top-view of a cross-sectioned part of the propellor system depicted in FIG. 3;

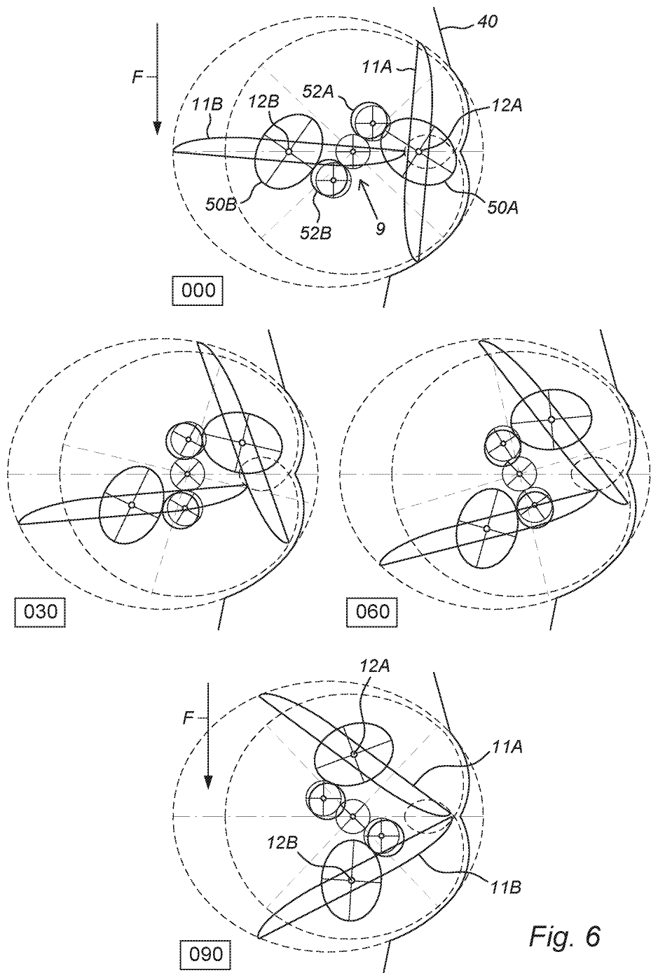

FIG. 5 shows a bottom-view of a common wheel of the propellor system depicted in FIG. 4;

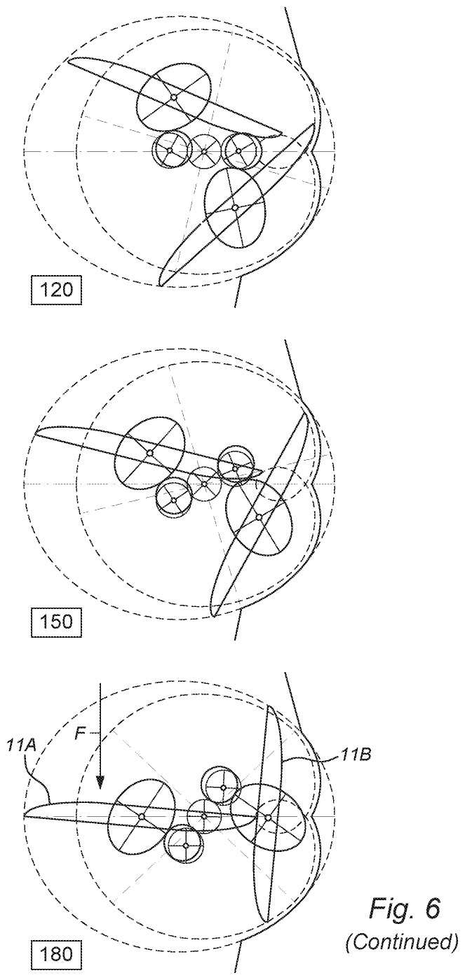

FIG. 6 shows a top-view of one pair of rotatory blades according to FIG. 4, during subsequent phases of rotation of the common wheel;

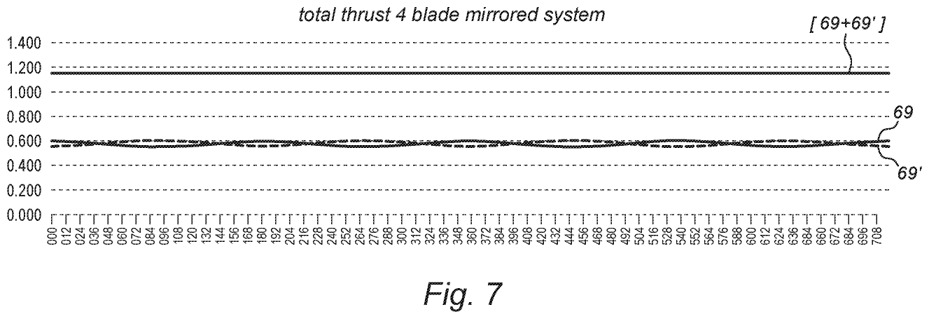

FIG. 7 shows the resultant thrust power that is exerted onto a unidirectional fluid flow by the propellor system according to FIG. 1, during operation of the propellor system over a period of time.

FIG. 1 shows a propellor system 1 in a dual configuration, which comprises an bottom supporting body 3a, and an upper supporting body 3b, which are flat structures configured to be integrated within a channel in a fixed position. A kinetic interaction system 5 is on the upper side connected to the upper supporting body 3b by two upper wheel axes 7 and 7′ over which two respective upper common wheels (non-visible) are rotatable. At the bottom supporting body 3a, and in a mirror-symmetrical fashion to the upper supporting body 3b, the kinetic interaction system 5 is connected to respective bottom common wheels 9 and 9′ which are rotatable over respective bottom wheel axes (non-visible; positioned in line with the upper wheel axes 7 and 7′).

On each common wheel 9 and 9′, a pair of rotatory blades 11 and 11′ (only one is visible) is rotatably mounted by means of their respective blade axes 12 and 12′. The pair of rotatory blades 11 connected to a common wheel 9 is an embodiment of a kinetic interaction system that is in conformity with option (i) as defined above for the invention.

In the case that in the embodiment of FIG. 1, the common wheel 9 would be provided with only one single rotatory blade 11 (instead of two blades as depicted), such an embodiment would comply with having a kinetic interaction system in conformity with option (ii) as defined above for the invention.

FIG. 2 shows an individual rotatory blade 11 separated from the propellor system shown in FIG. 1. The rotatory blade 11 has an constant height H and constant width W, and is provided at upper and lower side with a blade axis 12 to be rotatably connectable to the common wheels 9 shown in FIG. 1.

The rotatory blade 11 has two opposed operational surfaces 14 and 14′ for kinetic interaction with a fluid flow, which surfaces 14 and 14′ are similar or identical, and are substantially shaped as planar surfaces which are provided with curved lateral end sections 16 and 16′ when viewed in cross-section perpendicular to the height direction H of the rotatory blade 11.

FIG. 3 shows a longitudinally cross-sectioned part of a channel 30 for conducting a unidirectional fluid flow, which comprises side walls 32 and an entry side 33 and an exit side 34 for unidirectionally conducting a flow of fluid F from the entry side to the exit side, which channel has a longitudinal section 35 that is provided with a likewise cross-sectioned part of the propellor system 1 shown in FIG. 1, which is fixedly connected to the channel 1 by support body 3a.

FIG. 4 shows a top view of a cross-sectioned part of a propellor system as depicted in FIG. 3, wherein the bottom common wheels 9′ and 9 and bottom supporting body 3a are shown as depicted in FIG. 1. Corresponding further features already indicated above with respect to FIG. 1-3, are indicated by the same reference numerals in FIG. 4. The longitudinal section 35 of the channel comprises two opposite side walls 40 and 40′.

FIG. 5 shows a bottom-view of a common wheel 9 of the propellor system depicted in FIG. 4, of which the complete circumference is provided with a toothed gearing 58 in order to engage with a suitable wheel gear (not depicted) that drives the rotation of the common wheel 9.

The center of the wheel 9 is provided with a wheel axis 7, which is rotatably connected to support body 3a (only a fragment of the support body is depicted). Fixated onto the support body 3a is a non-rotatory gear 60 (partly visible; partly indicated by dotted lines) which is in concentric position with the wheel axis 7.

The non-rotatory gear 60 is engagingly positioned between two blade gearings 62 which are composed of respective gears 54, 52 and 50 that are mounted onto the wheel 9 and which are positioned at diametrically opposed positions to each other. The non-rotatory gear 60 directly engages with gear 54 of the blade gearing 62 which is a circular gear that rotates over its concentric gear axis 56 that is rotatably connected to the wheel 9. The gear 54 is further provided with an eccentric circular gear 52 that is fixated onto the gear 54 in an eccentric position to the gear axis 56. The eccentric gear 52 engages with an elliptic or oval gear 50 having a center point that is provided with blade axis 12 onto which the rotatory blade is connected (as depicted in FIG. 4).

In the configuration shown, a rotation of the wheel 9 will set the gear 54 in motion as it circles around the non-rotatory gear 60. Consequently the gear 54 drives the gears 52 and 50 so that the blade axis 12 is rotated. Within the blade gearing 62 composed of gears 54, 52 and 50, the gear 54 thus functions as a connecting gear that connects with the non-rotatory gear 60 in order to transmit the rotational motion of the wheel 9 onto the blade axis 12.

FIG. 6 shows a sequence of seven diagrams each of which shows a top-view of one pair of rotatory blades 11A and 11B corresponding to the right pair of rotatory blades 11 shown in FIG. 4, during subsequent phases of rotation of the common wheel 9 when the propellor system is in operation. In each successive diagram shown, the phase of rotation the common wheel 9 rotates in anti-clockwise direction by 30 degrees over its central axis (not shown, but conform FIG. 4). The rotation of the common wheel is driven by a wheel gearing (not visible), and the subsequent phase of rotation of the common wheel is indicated by a three-digit number (i.e. 000 up to 180).

By virtue of the rotation of the common wheel 9 over its central axis the two respective blade gearings of blades 11A and 11B are driven, via respective circular gear 52A and 52B engaged with respective oval gear 50A and 50B, such that blade axes 12A and 12B are rotated and consequently the rotatory blades 11A and 11B are rotated. The circumferences of the oval gear and circular gear are provided with toothed gearing, such that the gearing ratio of circular to oval equals 1:2.

For the sake of visibility of the diagrams of FIG. 6, only the most relevant parts 50 and 52 of the blade gearing of each rotatory blade are shown, although the blade gearings comprise further additional parts conform FIG. 5.

Starting from the top left diagram (000 degrees) the orientation of rotatory blade 11B is perpendicular to the indicated unidirectional fluid flow F, whereas the orientation of rotatory blade 11A is aligned with the indicated unidirectional fluid flow F. The orientation of blade 11A is herein an idle orientation, meaning that a minimum of kinetic interaction with the fluid flow F is achieved. Simultaneously, the orientation of blade 11B is herein an active orientation, meaning that a maximum of kinetic interaction with the fluid flow F is achieved.

During subsequent phases (030 up to 150 degrees), the orientation and position of the blades 11A and 11B progresses, such that at 180 degrees (bottom right diagram) the orientation of both blades has exactly been switched such that blade 11A is in an active orientation, and blade 11B is in idle orientation. As both blades are identical and each blade has identical sides, and each blade has identical blade gearings, the subsequent phases of the common wheel rotation from 180 up to 360 degrees are identical to the phases shown in 000 up to 180 degrees, except that the blades 11A and 11B should be indicated reversely.

It is noted that from 090 degrees of rotation of the common wheel, the blade axis 12A of blade 11A will move with the unidirectional flow of fluid in the channel, which is prolonged for half a revolution of the common wheel, i.e. up to 270 degrees rotation (corresponding to the position depicted for blade 11B at 090 degrees). This trajectory from 090 to 270 degrees of rotation corresponds to a second half of revolution wherein the active orientation (at 180 degrees) is assumed. The complementary trajectory from 270 up to 090 degrees corresponds to a first half of revolution wherein the idle orientation is assumed (at 000 degrees). The same sequence applies to the blade 11B, however with a phase difference of 180 degrees.

FIG. 7 shows the resultant thrust power that is exerted onto a unidirectional fluid flow by the propellor system according to FIG. 1, over a period of time of operation wherein successive rotations of the common wheels 9 and 9′ are performed.

On the x-axis the degrees of rotation of the common wheels 9 and 9′ are indicated, and on the y-axis the amount of thrust is indicated for the separate common wheels during successive rotations by respective 69 and 69′ curves. The total thrust that is delivered by the propellor system indicated as [69+69′]. From this figure it can be directly derived that the propellor system achieves a virtually constant thrust power during its operation at constant rotation speed of the common wheels, resulting in an excellent efficacy and effectivity of the propellor system according to the invention.

1. A propellor system which is suitable for kinetic interaction with a fluid that flows unidirectionally through a channel,
wherein the propellor system comprises a supporting body which is configured to be integrated within the channel in a fixed position, and a kinetic interaction system which is provided on the supporting body such that the kinetic interaction system extends in an interior area of the channel when the supporting body is integrated in the fixed position,
wherein the kinetic interaction system includes either:
(i) at least one pair of rotatory blades, preferably at least two pairs of rotatory blades, wherein each pair of rotatory blades is provided in such a way that:
each rotatory blade has a planar shape comprising two opposite, operational surfaces which are designed for kinetic interaction with a fluid flow;
each rotatory blade comprises a respective blade axis over which the rotatory blade is rotatable, and a respective blade gearing which is drivingly engaged to the blade axis;
the two rotatory blades are rotatably mounted by means of their respective blade axes onto one side of a common wheel and at a distance from each other, wherein the common wheel comprises a wheel axis over which the common wheel is rotatable, and wherein the two blade axes are mounted onto the common wheel at two respective positions which are both eccentric to the wheel axis,
the common wheel is rotatably connected to the supporting body by virtue of the wheel axis, and is drivingly connected to a wheel gearing;
the rotation of the common wheel drives the two blade gearings in order to rotate the two blade axes simultaneously;
the configuration of the kinetic interaction system is such that the two blade axes and the wheel axis have a similar, or parallel, direction to each other;
during operation of the propellor system, the rotation of the common wheel in combination with the simultaneous rotation of each rotatory blade over its blade axis results in a combinatory rotation being performed by each rotatory blade, wherein each rotatory blade follows a cyclic trajectory per revolution of the common wheel, while the two rotatory blades do not contact with each other during their simultaneous rotations, or
(ii) a single rotatory blade, which is provided in such a way that:
the rotatory blade has a planar shape comprising two opposite, operational surfaces which are designed for kinetic interaction with a fluid flow;
the rotatory blade comprises a respective blade axis over which the rotatory blade is rotatable, and a respective blade gearing which is drivingly engaged to the blade axis;
the rotatory blade is rotatably mounted by means of its blade axis onto one side of a common wheel, wherein the common wheel comprises a wheel axis over which the common wheel is rotatable, and wherein the blade axis is mounted onto the common wheel at a position which is eccentric to the wheel axis,
the common wheel is rotatably connected to the supporting body by virtue of the wheel axis, and is drivingly connected to a wheel gearing;
the rotation of the common wheel drives the blade gearing in order to rotate the blade axis;
the configuration of the kinetic interaction system is such that the blade axis and the wheel axis have a similar, or parallel, direction to each other;
during operation of the propellor system, the rotation of the common wheel in combination with the simultaneous rotation of the rotatory blade over its blade axis results in a combinatory rotation being performed by the rotatory blade, wherein the rotatory blade follows a cyclic trajectory per revolution of the common wheel.

2. The propellor system according to claim 1, wherein the cyclic trajectory that the rotatory blade follows is conform the shape of a cardioid curve, in particular in view of the cyclic trajectory of a lateral end part of the rotatory blade.

3. The propellor system according to claim 1, wherein the cyclic trajectory of the two rotatory blades within one pair is similar or identical.

4. The propellor system according to claim 1, wherein the blade gearing of each rotatory blade has a gearing ratio of 1/2, such that one revolution of the common wheel results in half a rotation of the rotatory blade over its blade axis.

5. The propellor system according to claim 1, wherein the blade axes of two rotatory blades within each pair of rotatory blades are mounted onto the common wheel in opposed positions with respect to the wheel axis, preferably in diametrically opposed positions.

6. The propellor system according to claim 1, wherein during operation of the propellor system, the two rotatory blades within one pair execute their respective combinatory rotations simultaneously and with a phase difference, preferably a phase difference between 160 and 200 degrees, most preferably 180 degrees.

7. The propellor system according to claim 1, wherein during one revolution of the common wheel, the rotatory blade assumes an idle orientation for minimum kinetic interaction during a first half of the revolution of the common wheel, and the rotatory blade assumes an active orientation for maximum kinetic interaction during a second half of the revolution of the common wheel.

8. The propellor system according to claim 1, wherein during one complete revolution of the common wheel, the rotational speed of the rotatory blade gradually increases from a minimum rotational speed to a maximum rotational speed and subsequently gradually decreases from the maximum rotational speed to the minimum rotational speed, wherein preferably the ratio of maximum rotational speed versus minimum rotational speed is about 2:1.

9. The propellor system according to claim 7, wherein the maximum rotational speed is achieved during the first half of the complete revolution of the common wheel wherein the idle orientation of the rotatory blade is assumed, and the minimum rotational speed is achieved during the second half of the complete revolution of the common wheel wherein the active orientation of the rotatory blade is assumed.

10. The propellor system according to claim 8, wherein the blade gearing for each rotatory blade includes an elliptic or oval gear co-operating with a circular gear, wherein preferably the circular gear is an eccentrically rotating, circular gear.

11. The propellor system according to claim 1, wherein the blade gearing for each rotatory blade is mounted on the respective common wheel, wherein the blade gearing is positioned such that it includes one connecting gear that engages with a non-rotatory gear fixated onto the supporting body in a position concentric with the wheel axis.

12. The propellor system according to claim 1, wherein each rotatory blade has a height and a width, wherein the blade axis extends parallel to the height direction of the rotatory blade, and preferably the height of the rotatory blade is larger than the width of the rotatory blade.

13. The propellor system according to claim 1, wherein the opposed operational surfaces of each rotatory blade are similar or identical, and are substantially shaped as planar surfaces which are preferably provided with curved lateral end sections when viewed in cross-section perpendicular to the height direction of the rotatory blade.

14. The propellor system according to claim 1, wherein the kinetic interaction system comprises a first pair of rotatory blades and a second pair of rotatory blades,
wherein the first pair of rotatory blades is rotatably connected to a first common wheel, and the second pair of rotatory blades is rotatably connected to a second common wheel,
wherein the first common wheel and second common wheel are rotatably connected to the supporting body such that the first common wheel and second common wheel are arranged adjacent to each other in a coplanar configuration, and are drivingly connected to a respective first and second wheel gearing, wherein preferably the first common wheel and the second common wheel rotate in opposite directions to each other during operation.

15. The propellor system according to claim 14, wherein the first pair of rotatory blades and the second pair of rotatory blades rotate in opposite directions and in mirror symmetry to each other, and the rotational phase of the rotatory blades of the first common wheel and the rotational phase of the rotatory blades of the second common wheel are different from each other by a phase difference of 60 to 120 degrees, preferably 80 to 100 degrees, more preferably 90 degrees.

16. The propellor system according to claim 14, wherein the cyclic trajectory of the rotatory blades of the first pair partially overlaps with the cyclic trajectory of the rotatory blades of the second pair, in particular in view of the cyclic trajectory of the lateral end part of each rotatory blade.

17. The propellor system according to claim 1,
comprising a first kinetic interaction system according to option (ii), and a second kinetic interaction system according to option (ii), wherein the first kinetic interaction system comprises a single rotatory blade that is rotatably connected to a first common wheel, and the second kinetic interaction system comprises a single rotatory blade that is rotatably connected to a second common wheel,
wherein the first common wheel and the second common wheel are rotatably connected to the supporting body such that the first common wheel and second common wheel are arranged adjacent to each other in a coplanar configuration, and are drivingly connected to a respective first and second wheel gearing, wherein preferably the first common wheel and the second common wheel rotate in opposite directions to each other during operation.

18. The propellor system according to claim 17, wherein the single rotatory blade of the first kinetic interaction system and the single rotatory blade of the second kinetic interaction system rotate in opposite directions and in mirror symmetry to each other, and the rotational phase of the first common wheel and the second common wheel are different from each other by a phase difference, preferably a phase difference between 160 and 200 degrees, most preferably 180 degrees.

19. The propellor system according to claim 17, wherein the cyclic trajectory of the single rotatory blade of the first kinetic interaction system overlaps with the cyclic trajectory of the single rotatory blade of the second kinetic interaction system, in particular in view of the cyclic trajectory of the lateral end part of each rotatory blade.

20. A channel for conducting a unidirectional fluid flow, which comprises side walls and an entry side and an exit side for unidirectionally conducting a flow of fluid from the entry side to the exit side, which channel is provided with a propellor system according to claim 1,
wherein the supporting body of the propellor system is fixedly integrated within the channel, and the kinetic interaction system of the propellor system includes at least one common wheel which is provided in such a way that:
during a complete revolution of each common wheel, the rotatory blade assumes an idle (inactive or drag) orientation for minimum kinetic interaction during a first half of the complete revolution of the common wheel, and the rotatory blade assumes an active (thrust) orientation for maximum kinetic interaction during a second half of the revolution of the common wheel;
each common wheel rotates against the unidirectional flow of fluid in the channel during the first half of the complete revolution, and the common wheel rotates with the unidirectional flow of fluid in the channel during the second half of the complete revolution,
wherein the first half of the revolution is performed at a small distance from the nearest side wall of the channel whereas the second half of the revolution is performed at a large distance from the nearest side wall of the channel.

21. The channel according to claim 20, wherein the propellor system is fixedly integrated in a longitudinal section of the channel through which the fluid flow is conducted, which longitudinal section has a width between opposed side walls of the channel which width is not more than 20% larger, preferably not more than 10% larger, than the width necessary for allowing the rotatory blades to execute their respective cyclic trajectories during operation without contacting the opposed side walls.
